(19) United States
(12) Patent Application Publication
(10) Pub. No.: US 2009/0219869 A1
(43) Pub. Date: Sep. 3, 2009

(54) METHOD FOR COMMUNICATION IN A MOBILE COMMUNICATION NETWORK

(75) Inventors: Maurice Edwiges, Saint Pierre du Perray (FR); Amaud Gonguet, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/160,011

(22) PCT Filed: Dec. 29, 2006
(86) PCT No.: PCT/FR06/51438

§ 371 Date: Nov. 13, 2008

(30) Foreign Application Priority Data
Jan. 4, 2006 (FR) 0650025

(51) Int. Cl. H04W 72/04

(52) U.S. Cl. 370/329

(57) ABSTRACT

The invention pertains to the field of reservation methods for communication within a mobile communication network. It is a reservation method for communication within a mobile communication network (10) comprising access points for accessing the mobile communication network and mobile terminals intended to be connected to the access points. For a mobile terminal (40) intended to follow a predetermined route including a list of fixed access points, the resources needed to maintain a minimum quality of service threshold during a communication of said mobile terminal when said mobile terminal changes connection from one of said fixed access points to another one of said fixed access points are firmly reserved beforehand from multiple successive fixed access points on said list.

The invention pertains to the field of reservation methods for communication in a mobile communication network, as well as systems and servers that may implement said reservation methods for communication.

Whenever a person is led to use a reservation method for communication within a mobile communication network, often he or she would like to be guaranteed a minimum quality of service enabling him or her to operate under conditions analogous to those which he or she may have within his or her normal environment within a fixed communication network.

In the prior art, such as that described in European patent application EP 1458148 or European patent application EP 1324628, it is known, within the context of so-called “ad hoc” mobile communication networks, i.e. within the context of mobile networks made up of other mobile terminals, to firstly take prior quality of service measurements, then to reserve multiple potential pathways along which the communication data may be routed, and finally to free up numerous reserved resources which will ultimately not be used.

One disadvantage of this prior art is that it is extremely burdensome and complex. In fact, the advance reservation of resources to mobile access points, in a completely provisional manner, is particularly difficult to implement if the purpose is meant to actually guarantee a minimum quality of service threshold while the user of a mobile terminal participating in mobile communication is roaming, particularly when the connection changes from one access point to another access point.

The invention proposes to resolve this problem for one type of mobile terminal user roaming which is not considered within the prior art, to wit a situation wherein a user of a mobile terminal is roaming along a temporally and spatially predetermined route with a fairly high degree of accuracy, such as an accident-free train ride with no excessive delays. In this manner, knowing the spatial and temporal change of the user in advance with a fairly high degree of accuracy, it will become possible to firmly reserve the resources needed to maintain a minimum quality of service threshold from fixed access points within the network. It is beneficial to maintain a minimum quality of service threshold, because although any drop in the quality of service that occurs when a connection is changed may in and of itself harm the user, a minor loss of connectivity is even more potentially harmful, due to the fact that the entire session must be restored.

Because the fixed access points, which may, for example, be base stations, often constitute bottlenecks within the network, it is particularly beneficial to be able to properly reserve resources beforehand from these fixed access points, as the risk of not providing satisfaction if requests are too late is too high. A firm reservation means that resources are only reserved when resources are actually intended to be used, and not a large number of them for which it is known in advance that most will never be used, as with various potential pathways in the prior art, when only one of the potential reserved pathways will actually be used. Despite the adoption of a certain safety margin for a reservation time window, i.e. the period of reservation, whenever the resources will be reserved from multiple successive access points along the user's route, for a given future moment of expected usage, resources from a single access point will preferably be reserved, even if it remains possible that there will be some overlap between the time windows for reserving resources from two consecutive fixed access points along the route. The successive fixed access points are preferably successive, in which case, in particular, the corresponding time windows will also be consecutive; successive fixed access points may, however, not be consecutive, particularly when the user only benefits from a minimum quality of service during disparate periods, such as two videoconferences separated by a period of inactivity. Preferably, the only overlap between resource reservation time windows is between two consecutive time windows; in such a case, there is never any overlap between three or more resource reservation time windows: in this preferential situation, at a given moment, resources may only be reserved from a maximum of two fixed access points.

The invention discloses a reservation method for communication within a mobile communication network comprising access points for accessing the mobile communication network and mobile terminals intended to be connected to the access points, characterized in that for a mobile terminal intended to follow a predetermined route including a list of fixed access points, the resources needed to maintain a minimum quality of service threshold during a communication of said mobile terminal when said mobile terminal changes connection from one of said fixed access points to another one of said fixed access points are firmly reserved beforehand from multiple successive fixed access points on said list. The list of fixed access points may be predetermined. Preferably, the reservation step is preceded by a step of determining a list of fixed access points located along a predetermined route of a mobile terminal.

The invention also discloses a system comprising: a mobile communication network comprising access points for accessing the mobile communication network and mobile terminals intended to be connected to the access points; an Internet core network; an application network comprising means capable both of determining a list of fixed access points located along a predetermined route of a mobile terminal and of firmly reserving the resource beforehand from multiple fixed successive access points on said list, in such a way as to permanently guarantee said mobile terminal a minimum quality of service during a communication of said mobile terminal when said mobile terminal changes connection from one of said fixed access points to another one of said fixed access points.

The invention also discloses an application server for a mobile communication network comprising access points for accessing the mobile communication network and mobile terminals intended to be connected to said access points, said server being capable of firmly reserving the resource beforehand, based on a list of fixed access points located along a predetermined route of a mobile terminal, from multiple fixed successive access points on said list, in such a way as to permanently guarantee said mobile terminal a minimum quality of service during a communication of said mobile terminal when said mobile terminal changes connection from one of said fixed access points to another one of said fixed access points.

The invention will be better understood, and other characteristics and advantages will become apparent, upon reviewing the description below and the attached drawing, given by way of example, in which:

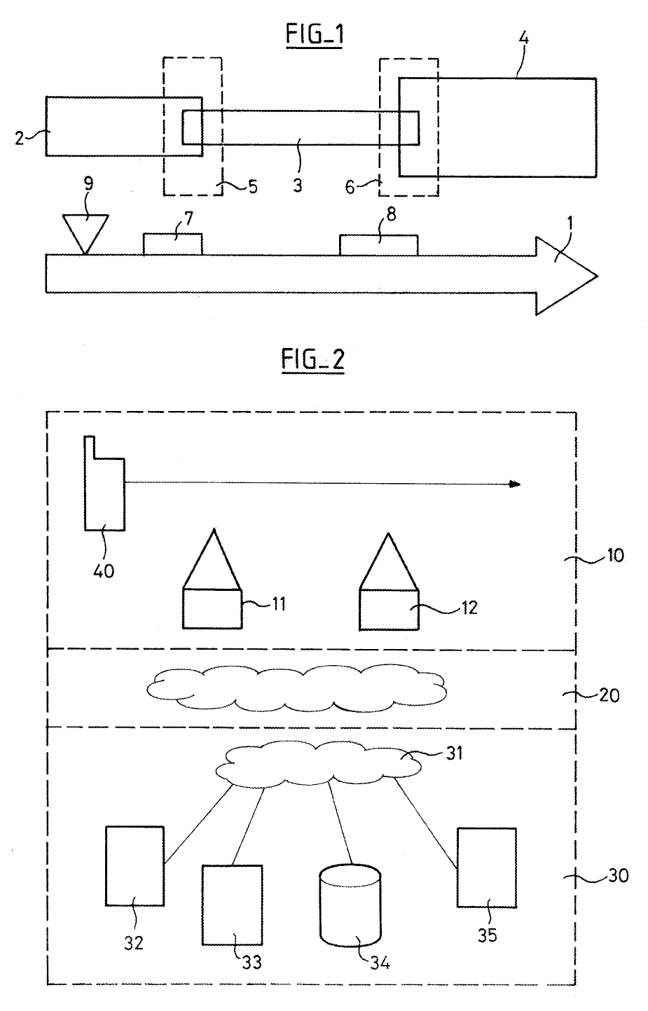

FIG. 1 schematically depicts an example time diagram emphasizing the step of reserving resources from multiple fixed access points located along a predetermined route of a mobile terminal, in accordance with the inventive reservation method for communication;

FIG. 2 schematically depicts an example system comprising a mobile communication network, an Internet core network, an application network comprising means implementing the reservation step, in accordance with the inventive reservation method for communication.

Preferably, the reservation step reserves the resource beforehand from multiple successive access points found on said list, respectively during time windows successively spread apart in time. This enables a reservation mode that strikes a good compromise between the safety of the reservation, as a reservation made well in advance has good chances of being accepted, and the effectiveness of the reservation, as the reservation is made during a relatively narrow time window during which the reserved resources will actually in all likelihood end up being used. Advantageously, the time windows do not overlap one another.

FIG. 1 schematically depicts an example time diagram emphasizing the step of reserving resources from multiple fixed access points located along a predetermined route of a mobile terminal, in accordance with the inventive reservation method for communication. Over time, depicted by a temporal axis 1, the user 9 will successively cross multiple cells 2, 3, and 4. Around the switchover from cell 2 to cell 3, a connection change area 5 is located. Around the switchover from cell 3 to cell 4, a connection change area 6 is located. At the beginning of the roaming, or whenever the user is roaming within another cell, i.e. before and preferably well before his arrival at connection change area 5, during a time window 7 taking place at the expected arrival time of the user at connection change area 5 and also including a period of time taking place before the expected arrival time of the user at connection change area 5, the resources needed to guarantee a minimum quality of service threshold are reserved from the fixed access point associated with cell 3. Likewise, during a time window 8 taking place at the expected arrival time of the user at connection change area 6 and also including a period of time taking place before the expected arrival time of the user at connection change area 6, the resources needed to guarantee a minimum quality of service threshold are reserved from the fixed access point associated with cell 4. Preferably, the reservation step reserves the resource beforehand from at least five successive access points on said list, if not from at least ten, which makes it possible to further reduce the likelihood of being refused reservation.

Preferably, the reservation step is not preceded by a step of quality of service measurement, which further simplifies the inventive reservation method for communication.

FIG. 2 schematically depicts an example system comprising a mobile communication network 10, an Internet core network 20, and an application network 30 comprising means implementing the reservation step, in accordance with the inventive reservation method for communication. The mobile communication network 10 comprises multiple fixed access points, such as base stations within a second-generation network or radio network controllers within a third-generation network, with only two fixed access points 11 and 12 being depicted in FIG. 1 for simplicity's sake. Preferably, the mobile communication network is at least third-generation, or potentially at least fourth-generation. A mobile terminal 40 moves from a first cell connected to the fixed access point 11 to a second cell connected to the fixed access point 12. The mobile communication network 10 is connected to the Internet core network 20 which is itself connected to the application network 30. The application network 30 comprises an application server 31 tasked with managing the inventive reservation method for communication on the application level. The application server 31 is connected to a trip reservation server 32, a video sending server 33, a database 34 containing information related to routes corresponding to trips that the user of the mobile terminal 40 may make, and a location server 35. The trip reservation server 32 reserves a trip at a given moment for a user of the mobile terminal 40 along the given route. The video sending server 33, at the moment desired by the user of the mobile terminal 40, sends the video he is requesting. The database 34 is capable of indicating, depending on whichever trip is chosen, which access points the user of the mobile terminal 40 is supposed to be able to connect to, and at which moments he is supposed to be able to connect to them. The location server 35 may constitute an additional guarantee, because by knowing over time where the user of the mobile terminal 40 is actually located, it may help the application server 31 modify or correct the information provided by the database 34. Using information provided by the trip reservation server 32, the database 34, and potentially the location server 35, the application server 31 reserves the resources beforehand from the fixed access points 11 and 12 on behalf of the mobile terminal 40, rather than the mobile terminal 40 itself.

Preferably, for an additional guarantee of the effectiveness of the reservation made, even when the spatially and temporally predetermined route is not traveled as expected, such as because the user does not reach the expected locations or because he reaches the expected locations but not at the expected times, the reservation method for communication comprises a step of locating the mobile terminal, making it possible to first detect a travel incident and then to cancel all or some of the resource reservation and/or to temporally shift all or some of the resource reservation.

Preferably, the communication of said mobile terminal 40 corresponds to the running of an application within an Internet core network 20 connected to said mobile terminal 40 via said mobile communication network 10. The communications envisioned may be in broadcast mode rather than peer-to-peer mode.

Preferably, the application is a real-time application. It may, for example, be a transaction operation on a stock market. This type of application makes any loss of activity of the application, however short, extremely harmful for the user of the mobile terminal. This phenomenon is even more marked when the application involves a transfer of video to the user of the mobile terminal. Preferably, the application is an application transmitting video in real time. This may, for example, be a video conference or a live viewing of a televised program.

A preferable example of a parameter representing quality of service pertains to bandwidth, with the minimum quality of service threshold corresponding to a minimum guaranteed bandwidth. Other parameters representative of quality of service may also be foreseen.

1. A reservation method for communication within a mobile communication network (10) comprising access points for accessing the mobile communication network and mobile terminals intended to be connected to the access points, characterized in that for a mobile terminal (40) intended to follow a predetermined route including a list of fixed access points, the resources needed to maintain a minimum quality of service threshold during a communication of said mobile terminal when said mobile terminal changes connection from one of said fixed access points to another one of said fixed access points are firmly reserved beforehand from multiple successive fixed access points on said list.

2. A reservation method for communication according to claim 1, characterized in that the reservation step reserves the resource beforehand from multiple successive access points on said list respectively during time windows (7, 8) that are successively spread apart in time.

3. A reservation method for communication according to claim 1, characterized in that the reservation step is not preceded by a step of measuring quality of service.

4. A reservation method for communication according to claim 1, characterized in that the communication of said mobile terminal corresponds to the running of an application within an Internet core network (20) connected to said mobile terminal via said mobile communication network.

5. A reservation method for communication according to claim 4, characterized in that said application is a real-time application.

6. A reservation method for communication according to claim 1, characterized in that the reservation method for communication comprises a step of locating the mobile terminal, making it possible to first detect a travel incident and then to cancel all or some of the resource reservation and/or to temporally shift some of the resource reservation.

7. A reservation method for communication according to claim 1, characterized in that the reservation step is preceded by a step of determining a list of fixed access points located along a predetermined route of a mobile terminal.

8. A system comprising:
a mobile communication network (10) comprising access points for accessing the mobile communication network and mobile terminals intended to be connected to the access points;
an Internet core network (20);
an application network (30) comprising means (31, 32, 33, 34, 35) capable both of determining a list of fixed access points (11, 12) located along a predetermined route of a mobile terminal (40) and of firmly reserving the resource beforehand from multiple successive fixed access points on said list, in such a way as to permanently guarantee said mobile terminal a minimum quality of service during a communication of said mobile terminal when said mobile terminal changes connection from one (11) of said fixed access points to another one (12) of said fixed access points.

9. An application server (31) for a mobile communication network comprising access points for accessing the mobile communication network (10) and mobile terminals intended to be connected to said access points, said server being capable of firmly reserving the resource beforehand, based on a list of fixed access points (11, 12) located along a predetermined route of a mobile terminal, from multiple fixed successive access points on said list, in such a way as to permanently guarantee said mobile terminal a minimum quality of service during a communication of said mobile terminal when said mobile terminal changes connection from one (11) of said fixed access points to another one (12) of said fixed access points.
